(19) United States
(12) Patent Application Publication
(10) Pub. No.: US 2014/0109659 A1
(43) Pub. Date: Apr. 24, 2014

(54) DEVICE AND METHOD FOR MEASURING MOISTURE CONTENT

(71) Applicant: Amphenol Corporation, Wallingford, CT (US)

(72) Inventors: Ratheesh Cheran, Kannur (IN); Manjunath Veerabhadran Chande, Bangalore (IN)

(73) Assignee: Amphenol Corporation, Wallingford, CT (US)

(21) Appl. No.: 13/659,443

(22) Filed: Oct. 24, 2012

(51) Int. Cl. G01N 27/22

(52) U.S. Cl. 73/73

(57) ABSTRACT

This disclosure describes improvements in moisture measurement (and related devices) that reduce variations that can occur due to surface moisture on a target object. Embodiments of the devices include a single conductive feature (e.g., a plate) and elements that can generate a moisture content value from capacitance of a target object. In one embodiment, the device can generate a signal from the fringe field capacitance. The device can use properties (e.g., frequency) of the signal to generate an output that encodes the moisture content value. The output and/or the information the output encodes may be found in a look-up table or other repository that correlates frequency to one or more pre-stored and/or pre-determined moisture content values.

### BACKGROUND OF THE INVENTION

The subject matter disclosed herein relates to devices to measure moisture content and, in one embodiment, to a device that correlates capacitance to the moisture content of a target.

Many devices are known to measure moisture content of materials, e.g., wood, concrete, tile, etc. These devices may use pins that, when in contact with a surface of the target object, can conduct a signal (e.g., a radio frequency (RF) signal). Other devices may use conductive plates that are positioned on opposing sides of the target object. This type of device can measure properties of the target object and relate the measured properties to moisture content. A problem with a two plate configuration, however, is that moisture (e.g., water droplets) between the conductive plates and the target object can cause errors in the moisture content measurement. This problem can lead to variations in measurements of moisture content across the target object when water droplets are present, e.g., on only certain test areas of the surface of the target object.

The discussion above is merely provided for general background information and is not intended to be used as an aid in determining the scope of the claimed subject matter.

### BRIEF DESCRIPTION OF THE INVENTION

This disclosure describes improvements in moisture measurement (and related devices). Embodiments of the devices below, for example do not require two-plate configurations found on many conventional devices. Rather, these embodiments employ a single conductive feature (e.g., a plate) in combination with elements that can measure capacitance of the target object and generate a moisture content value from the measured capacitance. In one embodiment, the device can generate a signal that exhibits properties (e.g., frequency) from the measured capacitance. The device can also generate an output that encodes the moisture content value, which in one example corresponds to the frequency value as found in a look-up table or other repository of pre-stored and/or pre-determined moisture content values.

This disclosure describes, in one embodiment, a device for measuring moisture content in a target. The device includes a measurement element comprising conductive material, a converter element coupled with the measurement element, and a processing element coupled with the converter element. In one example, the processing element is configured to receive a signal from the converter element, the signal encoding a frequency value that relates to a measured capacitance that results from contact between the target and the measurement element, select a moisture content value corresponding to the frequency, and generate an output encoding the moisture content value.

This disclosure also describes, in one embodiment, a method for operating a device to measure moisture content of a target. The method includes steps for receiving a first signal encoding a measured capacitance across the target and generating a second signal in response to the first signal. The second signal encodes a frequency value that relates to the measured capacitance. The method also includes steps for selecting a moisture content value corresponding to the frequency value and steps for generating an output encoding the moisture content value.

This brief description of the invention is intended only to provide a brief overview of the subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts a perspective view of an exemplary embodiment of a device for measuring moisture content of a target;

FIG. 2 depicts a bottom view of the device of FIG. 1;

FIG. 3 depicts a schematic view of the device of FIG. 1;

FIG. 4 depicts a flow diagram of an exemplary embodiment of a method to measure moisture content in a target; and

FIG. 5 depicts an example of a calibration apparatus for calibrating a device for measuring moisture content of a target.

### DETAILED DESCRIPTION OF THE INVENTION

Broadly, embodiments of the device below can translate capacitance of a target object to a moisture content value. These embodiments utilize fringe field effects, or leakage capacitance, to generate one or more first signals that reflect a measured capacitance across the target object. Further processing of these signals can generate one or more second signals, which exhibit a selected frequency value that relates to the measured capacitance. In one embodiment, the device below can select and/or assign the moisture content value from a pre-stored table with moisture content values and associated selected frequency values.

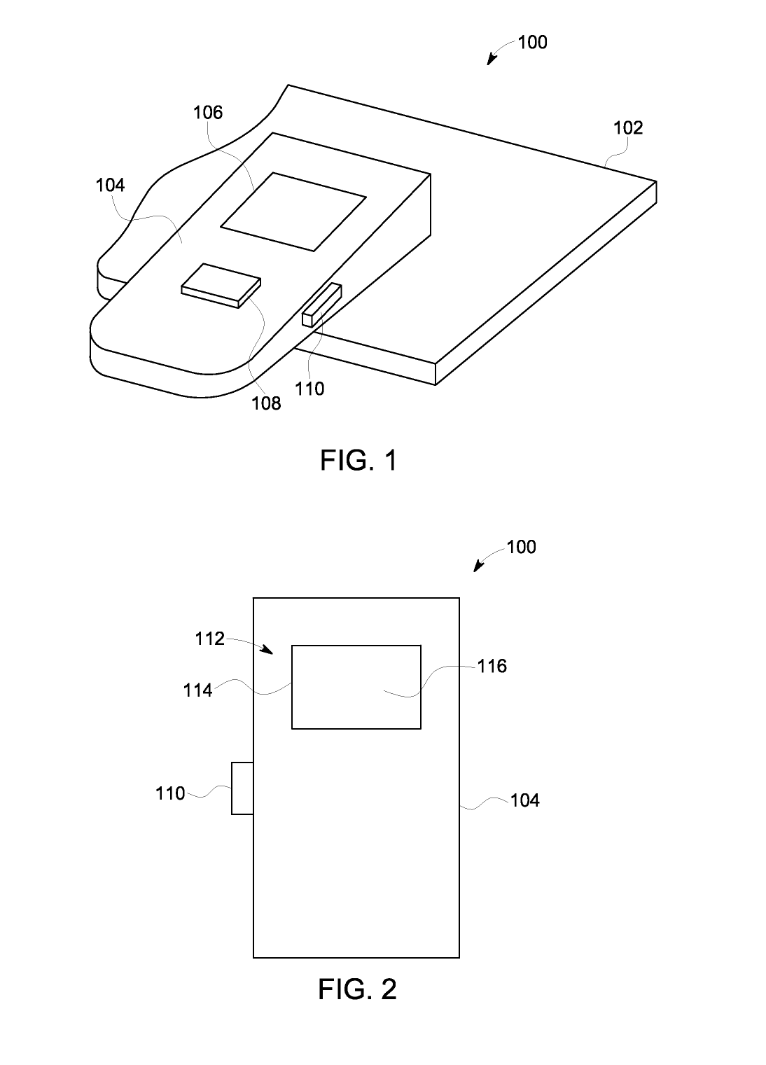

FIG. 1 illustrates an exemplary embodiment of a meter 100 that can measure moisture content of a target 102, e.g., wood, concrete, tile, etc. The meter 100 has a housing 104 in the form of a handheld device, but which can take various form factors as desired. The meter 100 also has a display 106 and one or more actuatable elements (e.g., a first button 108 and a second button 110) that are useful to receive and convey inputs and outputs to and from the meter 100.

As best shown in FIG. 2, which depicts a bottom view of the meter 100 of FIG. 1, the meter 100 includes a measurement element 112 that facilitates measurement of moisture content of the target 102 (FIG. 1). The measurement element 112 embodies a plate 114, which secures to the housing 104 and/or other structure of the meter 100. As set forth above, and in the discussion that follows, the plate 114 operates as part of a parallel-plate capacitor. However, unlike conventional devices that feature two plates to form the parallel-plate capacitor, the meter 100 only requires one plate (e.g., plate 114). This single-plate arrangement simplifies construction of the meter 100. Moreover, the meter 100 can provide more accurate and uniform readings of moisture content because the single-plate configuration is not susceptible to interference, e.g., interference from moisture on the surface of the target 102.

In one embodiment, the plate 114 secures in and/or to the housing to expose a surface 116. During implementation, the surface 116 contacts the outer surface of the target 102 (FIG. 1) when the meter 100 is in position to collect moisture content data. Subsequent actuation, e.g., of the first button 108 and/or the second button 110, with the meter 100 in the contact position causes the meter 100 to acquire data that relates to the moisture content of the target 102 (FIG. 1).

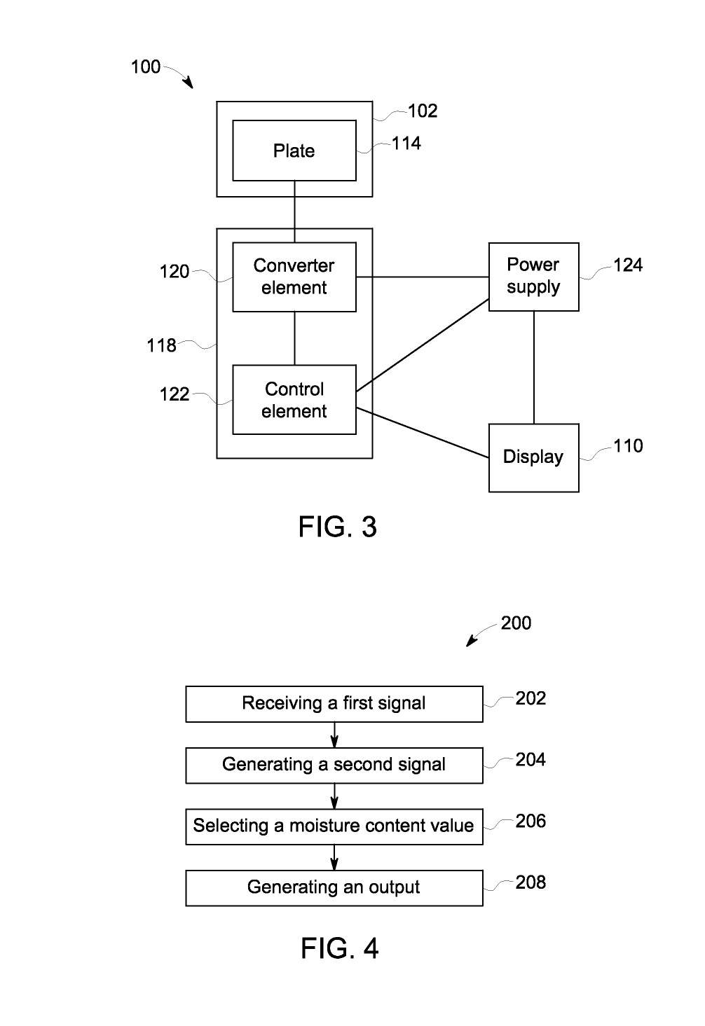

FIG. 3 illustrates a schematic diagram of the meter 100 to focus the discussion on exemplary components and elements of the proposed device. In the example of FIG. 3, the plate 114 couples with a processing element 118, which can generate an output to the display 110. Examples of the output convey information from which an end user can understand the moisture content of the target 102. In one embodiment, the processing element 118 includes a converter element 120 and a control element 122. Examples of the control element 122 can include microprocessors and related computational devices. Memory may also be required to store data and executable instructions, as desired. The computational devices can execute one or more of the executable instructions, which instruct operation of the meter 100, e.g., to acquire and display the moisture content of the target 102 (FIG. 1). A power supply 124 provides an electrical signal (e.g., current, voltage, etc.) to energize the components of the meter 100.

FIG. 4 depicts a flow diagram of a method 200 to measure moisture content on the meter 100 of FIGS. 1, 2, and 3. The method 200 includes, at step 202, receiving a first signal encoding a capacitance measurement and, at step 204, generating a second signal from the first signal exhibiting a selected frequency value. The method 200 also includes, at step 206, selecting a moisture content value that corresponds to the selected frequency value and, at step 208, generating an output encoding the moisture content value.

The step of generating the first signal (e.g., at step 202) occurs by way of deploying the meter 100 to measure capacitance across the target 102. Capacitance reflects a change in dielectric constant of the target 102, which in turn varies as the moisture content the target 102 increases and decreases. In one embodiment, the meter 100 measures capacitance by forming part of the parallel-plate capacitor (discussed above) that includes a first conductive plate, a second conductive plate, and a dielectric disposed therebetween. As shown in FIG. 3, the plate 114 and the target 102 act, respectively, as the first conductive plate and the dielectric. However, implementation of the proposed meter 100 does not require a physical manifestation of the second conductive plate. Rather, the second conductive plate forms virtually, e.g., by way of the hand of an end user that handles the meter 100 during measurement. This second or “virtual” conductive plate forms a return path for the fringe field and/or leakage capacitance of the parallel-plate capacitor that penetrates the target 102.

To generate the second signal (e.g., at step 204), the converter element 120 can include a circuit and/or collection of discrete electrical elements that can cause the second signal to exhibit certain signal parameters including the selected frequency value. Examples of this circuit/element include timer circuits (e.g., a 555 timer, a Schmitt trigger, an RC circuit, etc.). These timer circuits can receive the first signal and, in one example, use and/or respond to the first signal to assign the selected frequency value to the second signal. Use of the selected frequency value addresses problems with noise and other discrete interference that can often disrupt and prevent accurate readings of moisture content.

The step of selecting the moisture value (e.g., at step 206) can, in one example, correlate the selected frequency value to a moisture content value. In one example, the control element 122 correlates the frequency output with moisture values that are pre-stored and/or available, e.g., in memory and/or repository of the meter 100. The pre-stored moisture content values may reside in a look-up table and/or scale that includes the selected frequency value and, in one example, one or more corresponding moisture content values.

An example of a look-up table is found in Table 1 below:

TABLE 1

| Selected Frequency Value | Moisture Content Value |
|---|---|
| 100 | 500 |
| 200 | 1000 |
| 300 | 1500 |
| 400 | 2000 |

Values for the moisture content value can reflect the exact moisture content or, as in the example above, define a relative scale for the moisture content, as desired. Use of the relative scale can provide the end user with information that is more easily understood, e.g., “dry” for moisture content values of 100-999, “damp” for moisture content values from 1000-1999, and “wet” for moisture content values of 2000 and greater. In one example, the relative scale includes a number of pre-determined values that are stored on memory.

The step of generating the output (e.g., at step 208) can display a numeric value that relates to the moisture content value on the display 106. This feature may show the actual number (e.g., 500, 1000, 1500, 2000). This feature may also use some other indicator that can convey to the end user the moisture content of the target 102. As set forth above, for example, the display 106 may show a relative scale (e.g., dry, damp, wet), a color gradient, and/or other graphical representation from which the end user can glean the moisture content of the target 102.

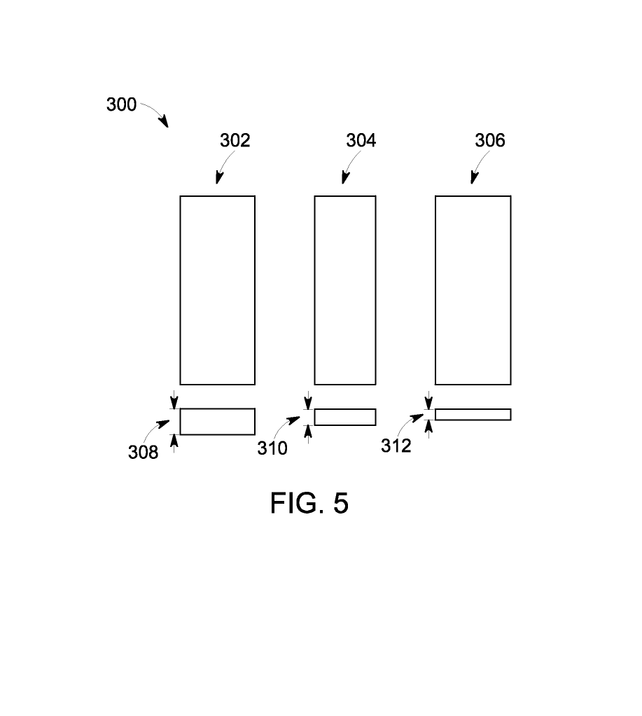

In one embodiment, the method 200 may also include steps for receiving one or more calibration signals and for matching the one or more calibration signals to a moisture content value. These steps calibrate the meter 100, which may allow the meter 100 to provide more accurate measurement of moisture content. FIG. 5 illustrates an example of a calibration apparatus 300 that is useful to perform these calibration steps. The calibration apparatus 300 includes a plurality of material slides (e.g., a first material slide 302, a second material slide 304, and a third material slide 306). Examples of the material slides 302, 304, 306 can comprise materials that are impermeable to liquids (e.g., have properties that prevent the material slide 302, 304, 306 from absorbing moisture). In one example, the material slides 302, 304, 306 comprise copper. Moreover, the materials slides 302, 304, 306 can be of different thicknesses (e.g., a first thickness 308, a second thickness 310, and a third thickness 312).

Implementation of the calibration steps may require positioning of the meter 100 (FIGS. 1, 2, and 3) to place the measurement element 112 in contact with one of the material slides 302, 304, 306. Once in position, the meter 100 operates to acquire data and, in turn, generates a calibration signal. The meter 100 generates the second signal from the calibration signal, wherein the selected frequency value of the second signal corresponds to the capacitance across the selected material slide 302, 304, 306. The meter 100 can then match the selected frequency value of the second signal with a moisture content value, e.g., as discussed above. Designs and dimensions of the material slides 302, 304, 306 cause the meter 100 to measure capacitance that corresponds to certain specified moisture content values, e.g., these designs exhibit known values of dielectric constant that can be associated with specified moisture content values. For example, the material slide 302 may correspond to a 16.5% moisture content value, the material slide 304 may correspond to a 22% moisture content value, and the material slide 306 may correspond to a 55% moisture content value. Thus, in one implementation, the meter 100 can match the frequency value for each of the material slides 302, 304, 306 with the corresponding moisture content value (e.g., 16.5%, 22%, 55%) that is pre-stored, e.g., the look-up table Table 1. The meter 100 can thereafter scale all other frequency values according to these calibrated results.

In view of the foregoing, embodiments of the proposed meter can measure moisture content using measured capacitance, but without the need to deploy opposing plates often found in parallel-plate capacitors. A technical effect afforded embodiments of these meters is to simplify the construction and implementation of the meter, as well as to avoid problems with interference and noise that may prevail, e.g., when moisture is present on the surface of the target under test. In one embodiment, the invention may embody a device for measuring moisture content in a target, the device comprising a measurement element comprising conductive material, a converter element coupled with the measurement element, a processing element coupled with the converter element, memory, and executable instructions stored on memory and configured to be executed by the processing element. The executable instructions comprising instructions for receiving a signal from the converter element, the signal encoding a frequency value that relates to a measured capacitance that results from contact between the target and the measurement element. The executable instructions also comprising instructions for selecting a moisture content value corresponding to the frequency and for generating an output encoding the moisture content value.

Moreover, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. Examples of a computer readable storage medium include an electronic, magnetic, electromagnetic, and/or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms and any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In still other configurations, the program code may be executed on one or more embodiments of the devices (e.g., measurement devices) discussed and contemplated herein.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device for measuring moisture content in a target, said device comprising:
a measurement element comprising conductive material;
a converter element coupled with the measurement element;
a processing element coupled with the converter element,
wherein the processing element is configured to receive a signal from the converter element, the signal encoding a frequency value that relates to a measured capacitance that results from contact between the target and the measurement element, to select a moisture content value corresponding to the frequency, and to generate an output encoding the moisture content value.

2. The device of claim 1, wherein the converter element comprising a timer circuit that couples with the processing element, and wherein the timer circuit generates the frequency value in response to the measured capacitance.

3. The device of claim 2, wherein the timer circuit comprises a 555 timer circuit.

4. The device of claim 2, wherein the timer circuit comprises a Schmidt timer circuit.

5. The device of claim 2, wherein the timer circuit comprises an RC circuit.

6. The device of claim 1, further comprising a display coupled with the processing element, wherein the processing element is configured to display the output on the display.

7. The device of claim 6, wherein the output comprises a numeric value for the moisture content value that is displayed on the display.

8. The device of claim 6, wherein the output comprises a graphic representation for the moisture content value that is displayed on the display.

9. The device of claim 1, further comprising a look-up table stored on the memory, wherein the processing element is configured to access the look-up table to select the moisture content value.

10. The device of claim 9, wherein the look-up table associates moisture content values and moisture content values that define a relative scale for the moisture content of the target.

11. The device of claim 1, wherein the measurement element comprises a plate with a surface, and wherein the plate forms part of a parallel-plate capacitor that comprises the plate as a first conductive plate of the parallel-plate capacitor, the target, and a virtual manifestation of a second conductive plate of the parallel-plate capacitor that bounds the target with the first conductive plate.

12. The device of claim 11, wherein the measured capacitance utilizes a fringe field of the parallel-plate capacitor.

13. The device of claim 1, further comprising a housing enclosing one or more the measurement element, the converter element, the measurement element, the processing element, and memory.

14. A method for operating a device to measure moisture content of a target, said method comprising:
receiving a first signal encoding a fringe field measurement across the target;
generating a second signal in response to the first signal, the second signal encoding a frequency value that relates to the fringe field measurement;
selecting a moisture content value corresponding to the frequency value; and
generating an output encoding the moisture content value.

15. The method of claim 14, further comprising accessing a look-up table to select the moisture content value, the look-up table comprising one or more entries that associate a moisture content value to a frequency value.

16. The method of claim 14, further comprising:
receiving a calibration signal; and
matching the one or more calibration signal to a moisture content value,
wherein the frequency value of the calibration signal corresponds to a known moisture content value for the target.

17. The method of claim 16, wherein the calibration signals correspond to a thickness of a material slide that causes the device to generate the frequency value for the known moisture content.

18. The method of claim 14, wherein the measured capacitance utilizes a fringe field of a parallel-plate capacitor that comprises a first conductive plate, a second conductive plate, and the target therebetween, and wherein the first conductive plate comprises a physical manifestation and the second conductive plate comprises a virtual manifestation that can conduct the fringe field.
